(19) United States
(12) Patent Application Publication
(10) Pub. No.: US 2023/0415313 A1
(43) Pub. Date: Dec. 28, 2023

(54) COUPLING MECHANISM

(71) Applicant: Hilti Aktiengesellschaft, Schaan (LI)

(72) Inventor: Maximilian KNYRIM, Ehingen (DE)

(21) Appl. No.: 18/037,662

(22) PCT Filed: Nov. 12, 2021
(86) PCT No.: PCT/EP2021/081503

§ 371 Date: May 18, 2023

(30) Foreign Application Priority Data
Nov. 30, 2020 (EP) 20210522.7

(51) Int. Cl. B25B 27/10; F16H 25/20

(52) U.S. Cl. CPC B25B 27/10; F16H 25/20; F16H 2025/2075

(57) ABSTRACT

Power tool, in particular a pipe press, including a drive, a transmission device, a threaded spindle drive and a linear actuator, wherein a torque generated by the drive is transmissible via the transmission device and the threaded spindle drive to the linear actuator. The power tool includes a coupling device having a sleeve and a piston for converting a rotational movement generated by the transmission device into a linear movement, to be transmitted to the threaded spindle drive, from the transmission device to the threaded spindle drive, wherein a toothed profile for connecting the piston to the sleeve for conjoint rotation therewith is contained between the sleeve and the piston, with the result that the piston is arranged in a manner which allows it to move axially relative to the sleeve and to rotate with the threaded spindle drive.

The invention relates to a power tool, in particular a pipe press, comprising a drive, a transmission device, a threaded spindle drive and a linear actuator, wherein a torque generated by the drive is transmissible via the transmission device and the threaded spindle drive to the linear actuator.

### BACKGROUND

Various power tools for deformation and cutting processes are known from the prior art. By means of these special power tools, it is for example possible for reinforcement bars to be severed, for pipes to be mechanically connected or for hose clamps to be pressed on. The mechanical connection tasks also include so-called crimping, flanging and squeezing.

In order to realize the high pressing forces required for the crimping of steel pipes, for example, commercially available deformation machines have a pressing head which is driven by a pressing cylinder. Here, the pressing cylinder is commonly hydraulically driven for the purposes of moving the pressing head. An electric motor drives, in turn, a hydraulic pump, which outputs the linear movement of the pressing cylinder. Alternatively, there are also commercially available mechanical pressing, cutting and crimping tools which, instead of the hydraulics, generate the pressing pressure by means of a threaded spindle drive in combination with an electric motor. Here, the rotational movement of the electric motor is transformed by means of a threaded spindle into a linear movement to a linear actuator. These power tools commonly comprise a transmission which is connected between the threaded spindle drive and electric motor and which serves for reducing the required motor torque, in order to thus be able to dimension the motor to be smaller.

### SUMMARY OF THE INVENTION

However, these power tools known from the prior art often have the problem that the electric motor is exposed to a relatively high reaction force by the pressing movement of the tool, which is embodied as a pressing head. As a result, the electric motor can be subject to severe stress, resulting, in turn, in relatively high friction torques and inefficient operation of the electric motor.

It is an object of the present invention to provide a power tool, in particular a pipe press, comprising a drive, a threaded spindle drive and a linear actuator in order to solve the above mentioned problems and, in particular, to provide a power tool having a coupling device which, when a threaded spindle drive is driven, simultaneously allows axial sliding movement, with the result that an axial change in length in the drivetrain of the power tool is compensated while a torque is being transmitted.

In particular, the present invention provides a power tool, in particular a pipe press, comprising a drive, a transmission device, a threaded spindle drive and a linear actuator, wherein a torque generated by the drive is transmissible via the transmission device and the threaded spindle drive to the linear actuator.

According to the invention, the power tool comprises a coupling device having a sleeve and a piston for converting a rotational movement generated by the transmission device into a linear movement, to be transmitted to the threaded spindle drive, from the transmission device to the threaded spindle drive, wherein a toothed profile for connecting the piston to the sleeve for conjoint rotation therewith is contained between the sleeve and the piston, with the result that the piston is arranged in a manner which allows it to move axially relative to the sleeve and to rotate with the threaded spindle drive.

According to an advantageous exemplary embodiment, the toothed profile is in the form of a multi-tooth geometry. As a result, a particularly high resistance to rotation between the sleeve and the piston can be produced. At the same time, reliable axial movement of the piston relative to the sleeve is ensured.

Further advantages will become apparent from the following description of the figures.

Various exemplary embodiments of the present invention are illustrated in the figures.

The figures, the description and the patent claims contain numerous features in combination. A person skilled in the art will expediently also consider the features individually and combine them to produce useful further combinations.

### BRIEF DESCRIPTION OF THE DRAWINGS

In the figures, identical and similar components and assemblies are denoted by the same reference signs.

Specifically:

FIG. 1 shows a side view of a power tool according to the invention in the form of a pipe press;

FIG. 2 shows a sectional side view of the power tool in the exemplary form of a pipe press, with a drive, a coupling device, a threaded spindle drive, a linear actuator and a transmission device;

FIG. 3 shows a perspective sectional view of the transmission device with a part of the coupling device and a first and second bearing;

FIG. 4 shows a perspective sectional view of the coupling device;

FIG. 5 shows a sectional side view of a partial region of the interior of the power tool in a first state;

FIG. 6 shows a sectional side view of a partial region of the interior of the power tool in a second state; and

FIG. 7 shows a sectional side view of a partial region of the interior of the power tool in a third state.

### DETAILED DESCRIPTION

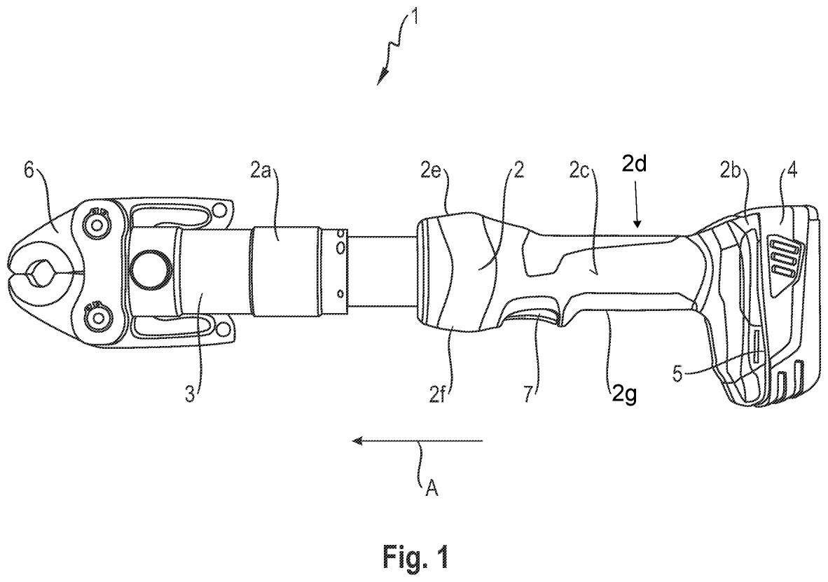

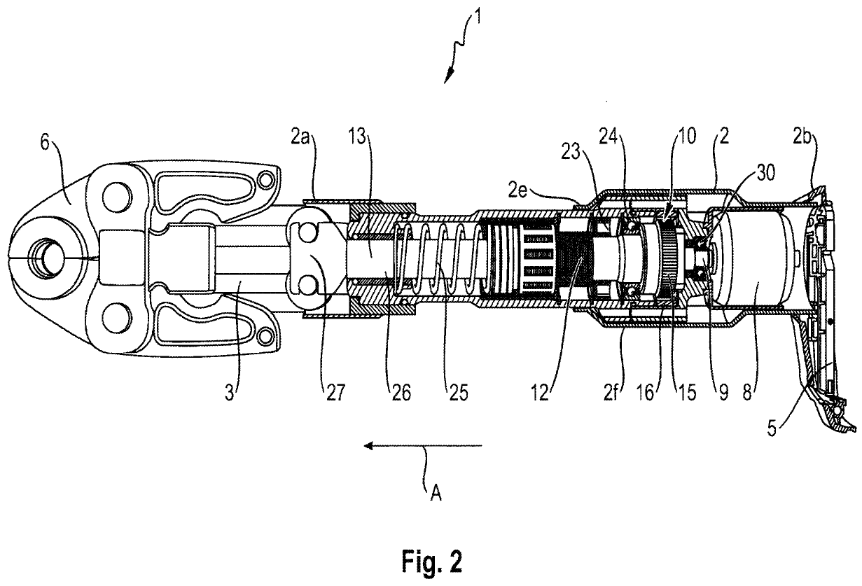

FIGS. 1 and 2 show a power tool 1 according to the invention in an exemplary embodiment as a pipe press. Instead of the embodiment as a pipe press, the power tool 1 may also be embodied as any other cutting or deformation tool. In particular, it is also possible for the power tool 1 according to the invention to be embodied as a dispensing apparatus for chemical substances, such as adhesive or plugging compound. Such dispensing apparatuses can also be referred to as dispensers.

As can be seen in FIG. 1, the power tool 1 embodied as a pipe press substantially has a housing 2, a tool fitting 3 and a power supply 4.

The housing 2 of the power tool 1 is of substantially cylindrical form and comprises a front end 2a, a rear end 2b, a left-hand side surface 2c, a right-hand side surface 2d, an upper side 2e and a lower side 2f. A central part 2g of the housing 2 serves as a handgrip for allowing the power tool 1 to be held and controlled.

The energy supply 4 is positioned at the rear end 2b of the housing 2 of the power tool 1. In the present exemplary embodiment, the power supply 4 is in the form of a rechargeable battery (also referred to as power pack or battery). The power supply 4 in the form of a rechargeable battery may be detachably connected by means of an interface 5 to the rear end 2b of the housing 2 of the power tool 1. The power tool 1 or the electrical consumers of the power tool 1 is or are supplied with electrical power by means of the rechargeable battery 4.

In an alternative embodiment of the present invention, the power supply 4 of the power tool 1 may also be embodied as an electrical cable for releasably connecting the power tool 1 to an electrical grid source (that is to say electrical socket).

The tool fitting 3 for detachably receiving and holding a tool 6 is positioned at the front end 2a of the housing 2 of the power tool 1. In the present exemplary embodiment, a tool 6 in the form of a deformation tool is positioned at the tool fitting 3. In the present exemplary embodiment, the deformation tool 6 is embodied as a so-called pressing head. The deformation tool 6 embodied as a pressing head serves substantially for the processing and in particular deformation of lines, that is to say pipes and tubes. During the deformation process, it is essentially the diameter of the lines which is reduced with the aid of the tool embodied as a pressing head. The lines are not shown in the figures.

An activation switch 7 is positioned on the lower side 2f of the housing 2 of the power tool 1. The power tool 1 can be started and stopped by means of the activation switch 7.

Substantially a drive 8, a drive shaft 9, a transmission device 10, a coupling device 11, a threaded spindle drive 12 and a linear actuator 13 are positioned in the interior of the housing 2 of the power tool 1. In the present exemplary embodiment, the drive 8 is embodied as a brushless electric motor.

In the present exemplary embodiment, the transmission device 10 is embodied as an eccentric transmission device. According to an alternative embodiment, the transmission device may also be embodied in a form other than an eccentric transmission device.

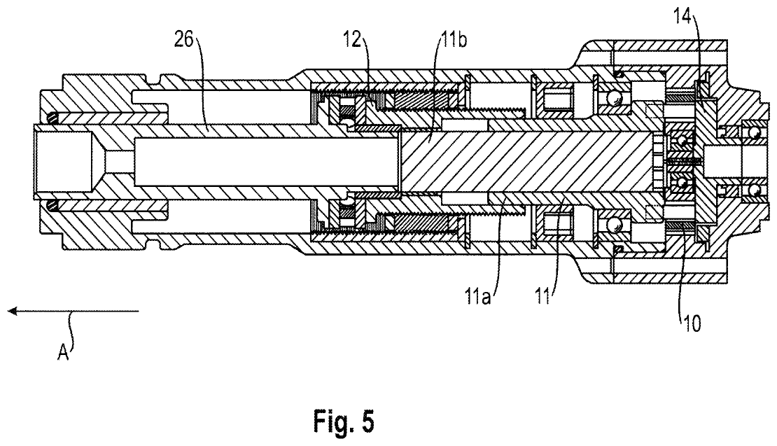

As illustrated in FIGS. 2 and 5, the drive 8 embodied as a brushless electric motor is connected via the drive shaft 9 to the transmission device 10 embodied as an eccentric transmission device. By means of the connection to the drive shaft 9, a torque generated in the drive 8 is transmitted from the drive 8 to the transmission device 10.

A rotational speed ratio between the drive 8 and the output shaft 11 can be generated by means of the transmission device 10.

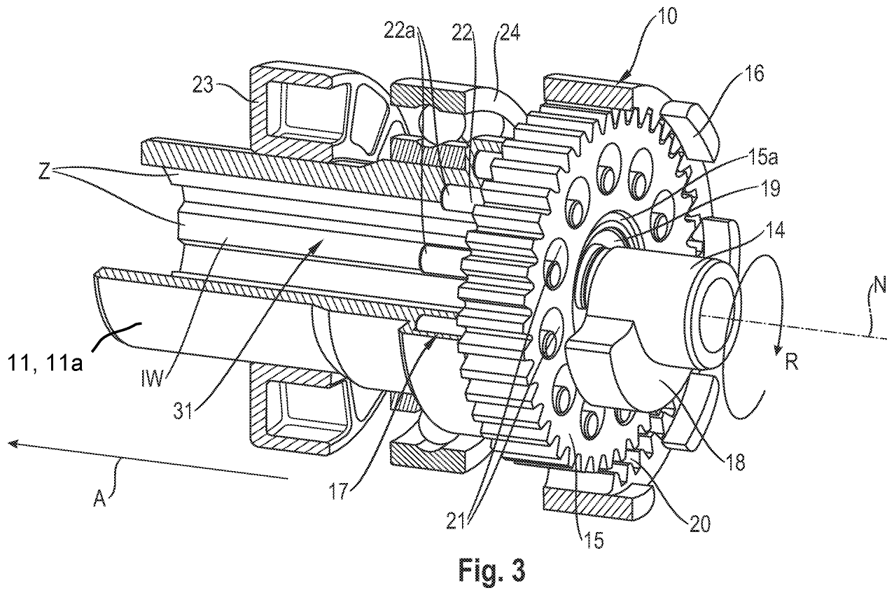

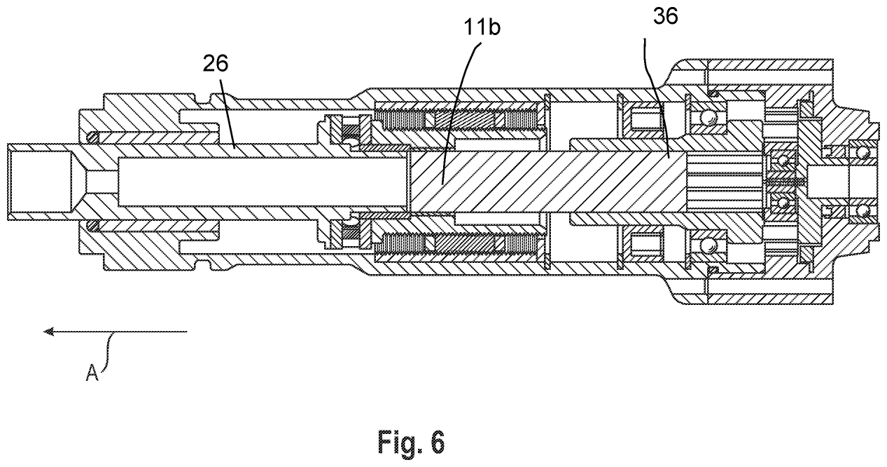

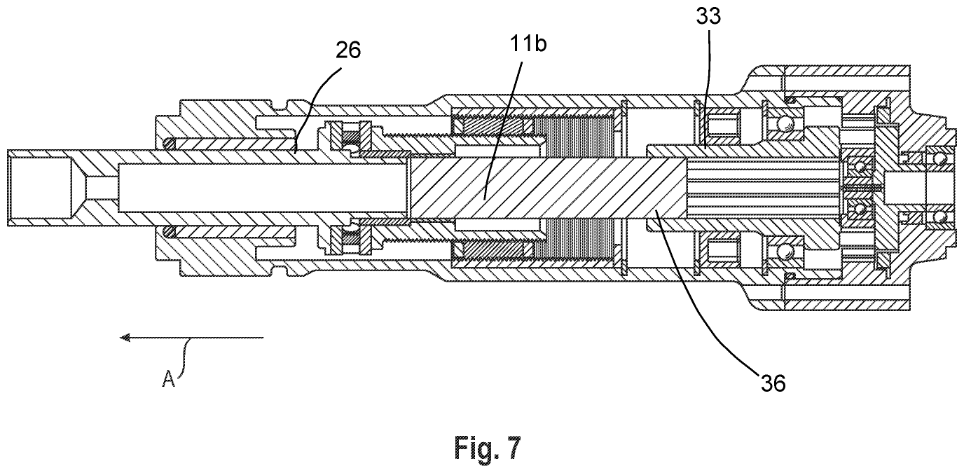

As shown especially in FIG. 3, the transmission device 10 embodied as an eccentric transmission device furthermore substantially comprises a drive eccentric 14, an eccentric gear 15, a ring gear 16, and a compensating coupling 17. The drive eccentric 14 has a compensating weight 18 (also referred to as a balance weight or balancing weight), which is connected to the drive 8 via the drive shaft 9. A bearing 30 is positioned between the drive eccentric 14 and the drive 8, cf. FIGS. 6 and 7. The eccentric gear 15 contains an aperture 15a for a ball bearing 19. The drive eccentric 14 is fitted into the ball bearing 19 and is thereby connected to the eccentric gear 15 for conjoint rotation therewith. Rotation of the drive eccentric 14 in the direction of rotation R also causes the eccentric gear 15 to rotate accordingly with a wobbling motion.

Moreover, the eccentric gear 15 is positioned in the ring gear 16. The ring gear 16 is connected to the inside of the housing 2 of the power tool 1 in a manner which prevents rotation relative to said housing. The eccentric gear 15 and the ring gear 16 have involute toothing 20, cf. FIG. 3.

Furthermore, the eccentric gear 15 contains a number of apertures 21 arranged in a circle around the drive eccentric 14. In the exemplary embodiment which is shown in the figures, the apertures 21 are in the form of eleven through holes. However, there may also be more or fewer than eleven through holes. According to an alternative embodiment, the apertures 21 can also be formed as blind holes. The blind holes are arranged in such a way that the respective closed end of a blind hole is arranged counter to arrow direction A, and the open end of the blind hole faces in arrow direction A.

In the present exemplary embodiment, the compensating coupling 17 is embodied as a parallel crank coupling with coupling elements 22. Each of the through holes 21 of the eccentric gear 15 serves to receive a coupling element 22. In the present exemplary embodiment, the coupling elements 22 are embodied as coupling pins.

The compensating coupling 17 may therefore be referred to as a parallel crank coupling or alternatively as a pin or crank coupling.

As can likewise be seen in FIG. 3, the free end 22a of each coupling pin 22 projects from the through holes 21 of the eccentric gear 15 in arrow direction A. The free ends 22a of each coupling pin 22 are in turn connected to the coupling device 11 in such a way that a torque can be transmitted from the coupling pins 22 of the compensating coupling 17 to the output shaft 11.

The coupling device 11 has a substantially cylindrical shape and comprises a sleeve 11a and a piston 11b (see, FIG. 5, e.g.). In principle, the coupling device 11 functions as an output shaft from the transmission device 10 to the threaded spindle drive 12.

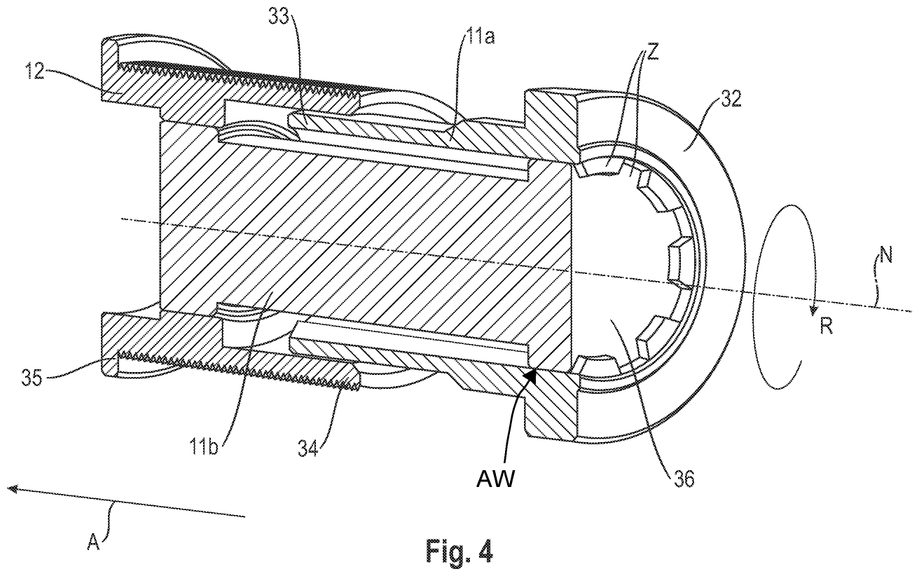

As can be seen in FIG. 4, the piston 11b is positioned in the interior of the sleeve 11a. The sleeve 11a has a cylindrical basic shape with a first end 32 and a second end 33. A step is provided between the first end 32 and the second end 33 of the sleeve, and therefore the outer shell of the sleeve 11a has a first diameter and a second diameter. Here, the first diameter is greater than the second diameter. As shown in FIG. 4, the first diameter is positioned ahead of the second diameter in arrow direction A. The inside diameter of the sleeve 11a has a constant diameter. The piston 11b likewise has a substantially cylindrical basic shape with a first end 34 and a second end 35. At the first end 34, the piston 11b has a gear element 36. The second end 35 of the piston 11b is connected to the threaded spindle drive 12 for conjoint rotation therewith, thus enabling a rotational movement of the piston 11b to be transmitted to the threaded spindle drive 12.

A toothed profile 31 (see, e.g, FIG. 3) for connecting the piston 11b to the sleeve 11a for conjoint rotation therewith is contained between an outer wall AW of the piston 11b and an inner wall IW of the sleeve 11a. The toothed profile 31 comprises a multiplicity of teeth Z, extending in arrow direction A, on the inner wall IW of the sleeve, and correspondingly configured teeth Z on the gear element 36 (see, e.g, FIG. 4) of the piston 11b. In the present exemplary embodiment, the cross-sectional area of each tooth Z is in the form of a symmetrical trapezoid, cf. FIG. 4. According to alternative embodiments, however, the cross-sectional area of a tooth Z can assume virtually any possible symmetrical or asymmetrical shape.

By virtue of the toothed profile 31 between the outer wall AW (see, e.g, FIG. 4) of the piston 11b and the inner wall IW (see, e.g, FIG. 3) of the sleeve 11a, the piston 11b is, on the one hand, connected to the sleeve 11a for conjoint rotation therewith and, on the other hand, the piston 11b can be moved axially in arrow direction A in the interior of the sleeve 11a.

With the aid of a main bearing 23 and a secondary bearing 24 (see, e. g., FIG. 2), the coupling device 11 is mounted in the interior of the housing 2 of the power tool 1. The main bearing 23 is positioned on the second diameter of the sleeve 11a, and the secondary bearing 24 is positioned on the first diameter of the sleeve. The main bearing 23 is embodied as a rolling bearing or ball bearing, and the secondary bearing 24 is embodied as a sliding bearing. According to an alternative exemplary embodiment, both the plain bearing 23 and the secondary bearing 24 can be embodied either as a rolling bearing or a sliding bearing. According to an alternative embodiment, it is also possible for just a single bearing to be provided.

As already described above, the coupling device 11 is connected to the compensating coupling 17 of the transmission device 10 (see, e.g, FIG. 3). The coupling device 11, in turn, is connected to the threaded spindle drive 12. The rotational movement of the coupling device 11 can be converted into a linear movement by means of the threaded spindle drive 12.

As can be seen from the figures, the threaded spindle drive 12 is connected to the linear actuator 13 (see, e.g, FIG. 2).

By virtue of the rotational movement of the drive shaft 9 in direction of rotation R around the axis of rotation N, the sleeve 11a and the piston 11b, inter alia, likewise rotate in direction of rotation R around the axis of rotation N, as a result of which the piston 11b is pushed in arrow direction A.

FIG. 5 shows the piston 11b in a first position, wherein the piston 11b is still in an initial position. The first end 34 of the piston 11b with the gear element 36 is still situated substantially at the transmission device 10. (See, e.g, FIG. 4).

In FIG. 6, the piston 11b has been moved in arrow direction A, with the result that the gear element 36 is situated approximately in the center of the sleeve 11a. The axial movement of the piston 11b in arrow direction A also results in the movement of the thrust rod 26 in arrow direction A.

In FIG. 7, the piston 11b has been moved further in arrow direction A, with the result that the gear element 36 of the piston 11b is situated at the second end 33 of the sleeve 11a. The thrust rod 26 has now been pushed to the maximum extent in arrow direction A by the piston 11b.

The linear actuator 13 comprises substantially a compression spring 25 and a thrust rod 26. Here, the compression spring 25 acts as a restoring spring for the linear actuator 13. (See, e.g, FIG. 2).

A force flow diverting device 27 is provided at the linear actuator 13. By means of the linear actuator 13 and the force flow diverting device 27, the linear force of the linear actuator 13 is transmitted to the tool fitting 3 such that the tool 6 in the form of a pressing head can be moved between an open and a closed position.

The drive 8, which is embodied as an electric motor, can rotate with a rotational speed value of between 10 000 and 30 000 rpm at a maximum extension and retraction speed of the linear actuator 13. In particular, a rotational speed value of between 15 000 and 18 000 rpm is provided for the drive 8.

### LIST OF REFERENCES

1 Power tool

2 Housing

2a Front end 2a of the housing

2b Rear end of the housing

2c Left-hand side surface of the housing

2d Right-hand side surface of the housing

2e Upper side of the housing

2f Lower side of the housing

3 Tool fitting

4 Power supply

5 Interface

6 Tool

7 Activation switch

8 Drive

9 Drive shaft

10 Transmission device

11 Coupling device

11a Piston

11b Sleeve

12 Threaded spindle drive

13 Linear actuator

14 Drive eccentric

15 Eccentric gear

15a Aperture in the eccentric gear

16 Ring gear

17 Compensating coupling

18 Compensating weight

19 Ball bearing

20 Involute toothing

21 Apertures in the eccentric gear

22 Coupling element

22a Free end on the coupling element

23 Main bearing

24 Secondary bearing

25 Compression spring

26 Thrust rod

27 Force flow diverting device

30 Bearing

31 Toothed profile

32 First end of the sleeve

33 Second end of the sleeve

34 First end of the piston

35 Second end of the piston

36 Gear element

AW Outer wall of the piston

IW Inner wall of the sleeve

Z Teeth of the toothed profile

1-2. (canceled)

3. A power tool comprising:
a drive;
a transmission;
a threaded spindle drive;
a linear actuator, a torque generated by the drive being transmissible via the transmission and the threaded spindle drive to the linear actuator; and
a coupling having a sleeve and a piston for converting a rotational movement generated by the transmission into a linear movement, to be transmitted to the threaded spindle drive, from the transmission to the threaded spindle drive, wherein a toothed profile for connecting the piston to the sleeve for conjoint rotation therewith is contained between the sleeve and the piston, with the result that the piston is arranged in a manner permitting the piston to move axially relative to the sleeve and to rotate with the threaded spindle drive.

4. The power tool as recited in claim 3 wherein the toothed profile is configured in the form of a multi-tooth geometry.

5. A pipe press comprising the power tool as recited in claim 3.
